(19) United States
(12) Patent Application Publication
(10) Pub. No.: US 2024/0240928 A1
(43) Pub. Date: Jul. 18, 2024

(54) INDUCTIVE POSITION DETERMINATION DEVICE FOR DETERMINING A POSITION OF A MOVABLY MOUNTED DRIVE COMPONENT OF AN AT LEAST PARTIALLY ELECTRICALLY DRIVEN VEHICLE, AND METHOD OF MANUFACTURE

(71) Applicant: ETO MAGNETIC GmbH, Stockach (DE)

(72) Inventors: Michael FEINDLER, Stockach (DE); Peter VINCON, Stockach (DE)

(21) Appl. No.: 18/559,912

(22) PCT Filed: May 5, 2022
(86) PCT No.: PCT/EP2022/062194

§ 371 Date: Mar. 11, 2024

(30) Foreign Application Priority Data
May 11, 2021 (DE) 10 2021 112 345.3

(51) Int. Cl. G01B 7/30; G01D 5/20

(52) U.S. Cl. CPC G01B 7/30; G01D 5/204

(57) ABSTRACT

An inductive position determination device, in particular an inductive angular position determination device, for determining a position and/or a movement of a movably supported drive component includes: the drive component which is formed from at least substantially at least electrically nonconductive materials, and an encoder element which is in particular integrated at least into the drive component and/or fastened on the drive component, which moves along with a movement of the drive component and which is formed from a metallic, at least substantially nonmagnetic and at least substantially electrically conductive material, wherein the encoder element is configured for interacting with a sensor module for the purpose of position determination, and wherein a density of the material of the encoder element is substantially greater than an, in particular average, density of the drive component.

### CROSS-REFERENCE TO RELATED APPLICATIONS

This patent application is a U.S. national stage application of international patent application PCT/EP2022/062194, filed on May 5, 2022, which is based on and claims priority to German patent application DE 10 2021 112 345.3, filed on May 11, 2021, the contents of which are incorporated herein by reference.

### BACKGROUND INFORMATION

The invention relates to an inductive position determination device, an at least partially electrically driven vehicle, an inductive position and/or movement determination method, and a method for manufacturing at least one encoder element for an inductive position determination device.

Position determination devices for movable drive components in vehicles are already known from the prior art. These position determination devices, such as the device described in U.S. Pat. No. 10,756,602 B2, are frequently based on Hall sensors, which in the case of at least partially electrically driven vehicles, can result in conflicts or measurement errors due to electromagnetic radiation which affects the Hall sensors, the electromagnetic radiation originating from high-voltage on-board electrical systems of the at least partially electrically driven vehicles. The mode of operation of an inductive position determination for movable drive components in vehicles is also known, although the metal targets which are used are generally massive and heavy.

The objective of the invention is, in particular, to provide a generic device which has advantageous properties with respect to a determination of a position of movable drive components in at least partially electrically driven vehicles. The problem is solved according to the invention.

### Advantages of the Invention

An inductive position determination device, in particular an inductive angular position determination device, for determining a position and/or a movement of a movably, in particular rotationally movably, supported drive component, is proposed, the inductive position determination device including the drive component which is formed from at least substantially at least electrically nonconductive materials, and an encoder element which is in particular integrated at least in the drive component and/or fastened on the drive component, which moves along with an, in particular rotational, movement of the drive component, preferably with a rotational drive movement of the drive component, and which is formed from a metallic, at least substantially nonmagnetic and at least substantially electrically conductive material, wherein the encoder element is configured for interacting with an, in particular inductive, sensor module for the purpose of position determination, and wherein a density of the material of the encoder element is substantially greater than an, in particular average, density of the drive component, in particular of the drive component without the encoder element. As a result, a particularly advantageous suitability for electrically driven vehicles can be achieved, in particular by advantageously combining an operating principle, which gets by without static magnetic fields, with a lightweight design. Advantageously, good electromagnetic compatibility can be achieved due to the inductive operating principle. Advantageously, a low susceptibility to interference from electromagnetic radiation can be achieved. Advantageously, due to the inductive operating principle, a risk of being affected by electromagnetic radiation from high-voltage on-board electrical systems of at least partially electrically driven vehicles can be kept low. Advantageously, an overall comparatively low density and thus an associated low overall weight can be achieved at the same time. “Configured” is in particular to mean specifically programmed, designed and/or equipped. An object being configured for a certain function is intended to be understood, in particular, to mean that the object fulfills and/or carries out this certain function in at least one state of application and/or operation.

In particular, an inductive position determination device is configured for detecting eddy current fields generated in a targeted manner in a metal target, in particular in an encoder element, and determining a position of the metal target, in particular of the encoder element, on the basis of the signals which were received. A “drive component” is to be understood to mean, in particular, a component of a drive system, which begins to move when the drive is activated. The drive component is designed, in particular, as a gear wheel, as a shaft or the like. In particular, the drive component can also be designed as a movably supported part of a transmission, in particular of the drive system. The drive system includes, in particular, an electric motor, for example, a brushless DC motor (BLDC motor) or a brushed DC motor (DC motor). The drive system includes a transmission, for example, a transmission having a spur gear-worm wheel set or a combination of spur gear stages having one or multiple worm wheel(s).

An “essentially electrically nonconductive material” is to be understood to mean, in particular, a material which has an electrical conductivity of less than 100 S/m, preferably less than 1 S/m, particularly preferably less than 10⁻² S/m and very particularly preferably less than 10⁻⁴ S/m. Preferably the “essentially electrically nonconductive material” is to be understood to be an electrical insulator. An “encoder element” is to be understood to be, in particular, an inductive position-determination-signal-generating element. Preferably, the “encoder element” is to be understood to be the metal target. In particular, the encoder element is configured for inductively interacting with the, in particular inductive, sensor module, in particular with the transmitting coils and receiving coils of the, in particular inductive, sensor module.

The encoder being integrated in the drive component is in particular to mean that all sides of the encoder element are surrounded at least in part by the drive component, preferably by a main material of the drive component. In particular, at least a portion of an encoder element which is integrated in the drive component is located in an interior of the drive component. In particular, the encoder element which is integrated in the drive component forms an integral part of the drive component, which preferably cannot be nondestructively removed from the component. The encoder element being fastened on the drive component is in particular to mean that the encoder element rests and/or is mounted on at least one surface of the drive component. Preferably, the encoder element is rotated along with a rotational movement of the drive component.

A “substantially nonmagnetic material” is to be understood to mean, in particular, a material having a magnetic permeability greater than 4, preferably greater than 40 and particularly preferably greater than 400. Preferably, the substantially nonmagnetic material is to be understood to mean a non-permanent magnetic and/or non-ferromagnetic material. For example, the substantially nonmagnetic material can be in the form of a paramagnetic material, for example, aluminum, or a diamagnetic material, for example, copper. An “essentially electrically conductive material” is to be understood to mean, in particular, a material which has an electrical conductivity of more than 10³ S/m, preferably more than 10⁴ S/m, particularly preferably more than 10⁵ S/m and very particularly preferably more than 10⁶ S/m. Preferably, the “substantially electrically conductive material” is to mean an electrical conductor, such as, for example, copper or aluminum. A “substantially greater” density is to mean, in particular, a density which is at least 25% greater.

Furthermore, it is proposed that the density of the encoder element is at least twice as great as the, in particular average, density of the drive component, and/or that a total mass of the encoder element is substantially less than a total mass of the drive component, in particular than a total mass of the drive component without the encoder element. As a result, a particularly high weight reduction of a position-determinable drive component can be advantageously achieved. In particular, the encoder element is lighter overall than the drive component despite having a substantially higher density in comparison to the drive component. In particular, a combination of the encoder element and the drive component is also lighter than a theoretical drive component which would consist entirely of the material of the encoder element. The expression “substantially less than” is intended to be understood to mean, in particular, at least 30% less, preferably at least 50% less, particularly preferably at least 100% less and very particularly preferably at least 300% less.

In addition, it is proposed that the encoder element has a thickness at least in a direction perpendicular to a main movement plane of the drive component, preferably in all spatial directions, which is substantially less than a thickness of the drive component in the same direction. As a result, a particularly high weight reduction of a position-determinable drive component can be advantageously achieved. In particular, the encoder element is at least largely planar and/or platelet-like. In particular, the encoder element, which is fastened on the drive component, covers at most a portion of a surface of the drive component on each side of the drive component.

If the encoder element is in the form of an, in particular thin, preferably plate-shaped, support part, which is connected form-lockingly and/or by substance-to-substance bond to the drive component, and/or in the form of an insert which has been introduced into the drive component, a precise position determination can be advantageously made possible. Advantageously, the encoder element therefore nearly exactly follows all movements of the drive component. A “plate-shaped” or “platelet-like” object is to be understood to mean, in particular, an object, the extension of which in a main extension plane of the object is substantially greater than, preferably at least three times as great as all extensions in planes perpendicular to the main extension plane. A “main extension plane” of an object is to be understood to mean, in particular, a plane which is parallel to a largest lateral surface of a smallest imaginary cuboid which just completely encloses the object and, in particular, extends through the center point of the cuboid. “Connected by substance-to-substance bond” is to mean, in particular, that the mass particles are held together by atomic or molecular forces, such as, for example, by soldering, welding, adhesive bonding and/or vulcanizing. The term “form-lockingly” is to be understood to mean, in particular, that adjacent surfaces of form-lockingly interconnected components apply a holding force upon one another, which acts in a normal direction of the surfaces. In particular, the form-lockingly interconnected components are geometrically engaged with one another. An encoder element formed as an insert can be extrusion-coated at least in some areas/at least partially by the drive component, in particular by the material of the drive component.

Moreover, it is proposed that the encoder element has a thickness of less than 500 μm, preferably less than 250 μm and preferentially less than 100 μm. Advantageously, at the same time, the encoder element has a thickness of more than 10 μm, preferably of more than 25 μm and particularly preferably of more than 40 μm. As a result, a particularly lightweight and nevertheless fully functional inductive position determination device can be advantageously made possible. When the encoder element is manufactured using a multiple-component injection molding process, the encoder element can also have a thickness of more than 500 μm in order to keep deformations of the encoder element resulting from dwell pressure processes and/or cooling processes as low as possible.

It is further proposed that the encoder element is formed as a coating on the drive component. As a result, a particularly lightweight and nevertheless fully functional inductive position determination device having an advantageously high durability can be advantageously made possible. In particular, the encoder element in the form of a coating is adhesively applied onto a surface of the drive component.

In addition, it is proposed that the drive component is formed from one or multiple plastic(s). As a result, advantageous material properties of the drive component can be achieved. In particular, advantageous magnetic properties can be achieved as a result. In particular, advantageous electrical properties can be achieved as a result. In addition, the inductive position determination device can be advantageously designed to be particularly lightweight as a result. Preferably, the drive component is made at least partially, preferably to a large extent and particularly preferably completely of a polyamide, in particular of a polyamide plastic having glass fiber reinforcement.

If the drive component is made at least partially of an electroplatable plastic, of a plastic which can be coated by means of the dusty plasma technique and/or of a plastic which can be coated by means of laser direct structuring technology (LDS), an advantageously simple manufacture of the inductive position determination device can be achieved. Advantageously, particularly thin encoder elements can be made possible as a result. Preferably, the drive component is formed at least partially, preferably largely and particularly preferably completely from the polyamide plastic with the glass fiber reinforcement, from a polyphenylene sulfide (PPS) plastic, from a polyoxymethylene (POM) plastic and/or from a polyether ether ketone (PEEK) plastic.

Furthermore, it is proposed that the drive component is formed as a transmission component, in particular as a gear wheel. As a result, a lightweight and/or electromagnetically compatible design of position-determinable transmission components, in particular gear wheels, can be advantageously made possible. The transmission component forms, in particular, a component of a transmission. A transmission is, in particular, a machine element with which movement variables, such as force or torque, can be modified. The transmission is in the form, in particular, of a cam mechanism, roller gearing or preferably as a gear transmission, in particular a toothed-belt drive or a gear wheel transmission. The transmission component is in the form, in particular, of a shaft or preferably a gear wheel. The gear wheel is in the form, in particular, of a gear rack, a bevel gear, a worm wheel or preferably a spur gear.

If the material of the encoder element, in particular apart from impurities, is exclusively copper, a manufacture of the encoder element, in particular mounting the encoder element on the drive component, by means of electroplating can be advantageously made possible. In addition, high sensitivity can be advantageously achieved due to the good electrical conductivity of the copper. Alternatively, if the material of the encoder element, in particular apart from impurities, is exclusively aluminum, a cost-effective and/or particularly lightweight design of the encoder element can be advantageously achieved.

If the encoder element is designed as at least one annulus segment which forms, in particular at most a semicircle, preferably at most one-third of a circle, advantageously at most one-fourth of a circle, particularly advantageously at most one-eighth of a circle and very particularly advantageously at least one-fifth of a circle, a particularly lightweight inductive position determination device can be advantageously made possible. In particular, it is conceivable that the encoder element is formed from multiple parts, in particular annulus segments, which are preferably distributed in or arranged on the drive component. Preferably, the individual parts, in particular annulus segments, of the encoder element in this case are arranged at uniform distances from one another in or on the drive component, for example, annularly around a rotation axis of a drive component which is in the form of a spur gear.

In addition, it is proposed that a main extension plane of the encoder element extends at least substantially parallel to a front face of the drive component which is in the form of a gear wheel, in particular a spur gear. As a result, in particular, an advantageous detection/monitoring of a rotation position of the gear wheel can be made possible. Preferably, the encoder element is arranged on the front face of the gear wheel. Preferably, the encoder element is fixedly connected to the front face of the gear wheel. The expression “substantially perpendicular” is to define, in this case, in particular, an orientation of a direction relative to a reference direction, wherein the direction and the reference direction, in particular viewed in a projection plane, enclose an angle of 90° and the angle has a maximum deviation of, in particular, less than 8°, advantageously less than 5° and particularly advantageously less than 2°.

In addition, it is also proposed that the drive component, in particular the gear wheel, is rotationally supported and the main extension direction of the encoder element extends at least substantially perpendicular to a rotation axis of the rotationally supported drive component. As a result, in particular, an advantageous detection/monitoring of a rotation position of the gear wheel can be made possible.

Furthermore, it is proposed that the inductive position determination device includes the, in particular inductive, sensor module, which in turn has at least one transmission coil for generating an excitation signal. As a result, a reliable determination of position can be advantageously achieved with a low susceptibility to interference from electromagnetic radiation. In particular, the transmission coil is configured for generating a magnetic field, in particular a magnetic alternating field, wherein the magnetic field, in particular the magnetic alternating field, is preferably configured for generating an eddy current field in the encoder element. In particular, the inductive position determination device includes a control and/or regulation unit. An “open-loop and/or closed-loop control device” is to be understood to mean, in particular, a unit having at least one electronic control unit. An “electronic control unit” is to be understood to mean, in particular, a unit having a processor unit, in particular a processor, and having a memory unit, in particular a memory chip, and having an operating program stored in the memory unit. In particular, the open-loop and/or closed-loop control device is configured for outputting an excitation signal to the transmission coil. Preferably, the excitation signal is in the form of a sinusoidal signal. Alternatively, the excitation signal could also be in the form of a cosine signal, a square-wave signal or a signal having another waveform.

Beyond this, it is proposed that the, in particular inductive, sensor module has at least two receiving coils, which are arranged, in particular, offset with respect to each other, for receiving a response signal which has been inductively generated by the encoder element in response to the excitation signal. As a result, a reliable determination of position can be advantageously achieved with a low susceptibility to interference from electromagnetic radiation. Advantageously, an absolute determination of position can be made possible due to the use of two receiving coils. In particular, the receiving coils transmit the response signal to the open-loop and/or closed-loop control device for evaluation. In particular, the response signal is generated in the encoder element by a mutual induction in response to the excitation signal. The open-loop and/or closed-loop control device is configured to evaluate the response signal registered by the receiving coils. The open-loop and/or closed-loop control device is configured for determining a position, in particular a rotation position, of the drive component from the response signal registered by the receiving coils.

Furthermore, an at least partially electrically driven vehicle, in particular a hybrid vehicle, a plug-in hybrid vehicle, a fuel cell vehicle and/or a purely battery-operated electric vehicle having the inductive position determination device is proposed. As a result, advantageous properties with respect to a vehicle weight and/or with respect to an electromagnetic compatibility of components of the vehicle can be achieved. In particular, the at least partially electrically driven vehicle includes the drive system. In particular, the inductive position determination device is configured for carrying out an on-board diagnostic (OBD) method, in particular of the drive system.

In addition, an inductive position- and/or movement determination method with the inductive position determination device is proposed. As a result, a position determination can be advantageously achieved with a low susceptibility to interference from electromagnetic radiation, which also advantageously permits a particularly lightweight design of the inductive position determination device.

Furthermore, a method for manufacturing at least one encoder element for the inductive position determination device is proposed, wherein, in order to form the, in particular thin, preferably plate-shaped, encoder element, a metallic, at least substantially nonmagnetic and at least substantially electrically conductive material is introduced into/applied onto a drive component which is formed from at least substantially electrically nonconductive materials. As a result, a particularly advantageous suitability for electrically driven vehicles can be achieved, in particular by advantageously combining an operating principle that works without static magnetic fields with a lightweight design. Advantageously, a low susceptibility to interference from electromagnetic radiation can be achieved.

In this context, it is proposed that the encoder element is electroplated onto the drive component which is formed, in particular, from one or multiple plastic(s). As a result, a simple and cost-effective manufacture of a thin encoder element, which forms, in particular, a coating, can be advantageously made possible, the encoder element being additionally fixedly connected to the drive component. In particular, at least one of the plastics in this case is formed as an electroplatable plastic, such as, for example, an acrylonitrile butadiene styrene copolymer (ABS) plastic, and acrylonitrile butadiene styrene copolymer polycarbonate (ABS-PC) plastic, a polyetherimide (PEI) plastic or, preferably, a polyamide with glass fiber reinforcement (for example, PA6.6 GF). In particular, the encoder element in this case is electroplated directly on a surface, in particular on a partial surface, of the drive component, in particular of the gear wheel. Due to the electroplating, an encoder element can be produced in the form of a single annulus segment or in the form of multiple annulus segments, which are spaced apart from one another, on a front face of the gear wheel. Preferably, the drive component is designed to allow for a partial electroplating of the surface made up of at least two different plastic materials, in particular of an electrically conductive plastic, such as, for example, a polycarbonate (PC) or Makralon, in the region of the drive component, which is/will be electroplated and of an (electrically nonconductive) technical plastic, such as, for example, an acrylonitrile butadiene styrene copolymer (ABS) or a polyamide (PA) for a remainder of the drive component. Such a drive component, in particular a gear wheel, which is formed from two different plastics, can be manufactured, inter alia, advantageously by means of a two-component injection molding process. The combinations ABS with PC and PA with Makralon have been shown to be combinations of plastics which are particularly advantageous for electroplating the drive component.

Alternatively or additionally, it is proposed that the encoder element is applied onto the drive component by means of the dusty plasma technique (also referred to as nanopowder plasma deposition technology), the drive component being formed, in particular, from one or multiple plastic(s), such as, for example, PA GF, PEEK, PPS or POM. As a result, a rapid and/or energy-saving and thus cost-effective manufacture of a thin encoder element, which forms, in particular, a coating, can be advantageously made possible, the encoder element being additionally fixedly connected to the drive component. Advantageously, a coating which is gentle on the material of the drive component can be made possible. In addition, a coating of the drive component having an encoder element made of aluminum can be advantageously made possible. The dusty plasma technique is based, in particular, on a combination of cold-active plasma and nano- or micro-powders. Due to the use of the dusty plasma technique, layers made of metals can be produced on two-and three-dimensional substrates made of plastic, advantageously without the use of chemicals for etching and pickling processes and advantageously without the need to subject the substrate to very high temperatures. In particular, during the metallization of the drive component by means of the dusty plasma technique, metal particles, for example, copper or aluminum particles, are continuously fed to a plasma beam which burns on the metal particles, such that they remain adhered on the surface of the drive component. Advantageously, the plasma is generated under atmospheric pressure. Advantageously, the drive component is activated and metallized in one operation. In particular, in the dusty plasma technique, the plasma is generated by means of a pulsed arc discharge, as a result of which a non-thermal plasma advantageously arises, the measurable temperature of which is only approximately 120° C. due to the imbalance of the energy content of lightweight electrons and heavy gas particles under atmospheric conditions, which temperature is sufficient, in particular, for burning on micro-/nano-powder made of copper or aluminum having a grain diameter of 0.1 μm to 20 μm.

Alternatively or additionally, it is proposed that the encoder element is applied onto the drive component by means of the laser direct structuring (LDS) technique, the drive component being formed, in particular, from one or multiple plastic(s), such as, for example, PA GF, PEEK, PPS, ABS, PEI, PC or POM. As a result, a cost-effective metallization of the drive component, in particular with a high precision of the design of the encoder element, can be advantageously achieved. In the LDS technique, in particular, an (organometallic) LDS additive is added to the plastic(s) of the drive component during manufacture (for example, by means of an injection molding process), the LDS additive being preferably activatable by a laser beam. In particular, a chemical reaction takes place on the plastic surface in this process, in which chemical reaction nuclei form, which act as catalysts in the metal coating, in particular copper coating, of the drive component, such that the metal, in particular the copper, permanently bonds with the activated part of the surface of the drive component in one further step in which the drive component is dipped into a zero-current metal bath, in particular a copper bath.

Alternatively or additionally, it is proposed that the encoder element is introduced as an insert in an injection molding process into the drive component which is in particular formed from one or multiple plastic(s). As a result, a cost-effective installation of the encoder element in the drive component can be advantageously made possible. Advantageously, the encoder element in this case is particularly well protected against damage from the outside (for example, due to scratching). In particular, the encoder element is extrusion-coated by the plastic(s) at least in some areas/at least in some sections using the injection molding process which is, in particular, a two-component injection molding process.

Alternatively or additionally, it is proposed that the encoder element is placed as a support part onto the drive component by means of a form-locking connection, the drive component being formed, in particular, from one or multiple plastic(s). As a result, a particularly simple installation of the encoder element can be advantageously made possible.

In particular, it is conceivable that a person skilled in the art reasonably combines two or more than two of the aforementioned manufacturing methods for applying or introducing encoder elements.

The inductive position determination device according to the invention, the vehicle according to the invention and the methods according to the invention are not to be limited to the above-described application and embodiment. In particular, the inductive position determination device according to the invention, the vehicle according to the invention and the methods according to the invention can have a number of individual elements, components, method steps and units, which differs from the number mentioned herein, for performing a mode of operation described herein.

### BRIEF DESCRIPTION OF THE DRAWINGS

Further advantages result from the following description of the drawing. Exemplary embodiments of the invention are shown in the drawings. The drawings, the description, and the claims contain numerous features in combination. Those skilled in the art will advantageously also consider the features individually and combine them to form other meaningful combinations, wherein:

FIG. 1 shows a schematic view of a vehicle with a drive system,

FIG. 2 shows a schematic perspective view of a portion of the drive system with an inductive position determination device,

FIG. 3a shows a schematic section through the inductive position determination device with a drive component and with an encoder element,

FIG. 3b shows a schematic section through the inductive position determination device with the drive component and with an alternative arrangement of the encoder element,

FIG. 3c shows a schematic section through the inductive position determination device with the drive component and with a second alternative arrangement of the encoder element,

FIG. 3d shows a schematic top view of the inductive position determination device with the drive component and with a third alternative arrangement of the encoder element,

FIG. 3e shows a schematic sectional view of a portion of the drive component with the third alternative arrangement of the encoder element,

FIG. 3f shows a schematic section through the inductive position determination device with the drive component and with a further alternative arrangement of the encoder element,

FIG. 4a shows a schematic side view of the inductive position determination device with the encoder element, a sensor module and the drive component,

FIG. 4b shows a schematic side view of the inductive position determination device with the encoder element, the sensor module and an alternatively positioned drive component,

FIG. 5 shows a schematic view of the sensor module,

FIG. 6a shows a schematic perspective view of the drive component with the encoder element,

FIG. 6b shows a schematic perspective view of the drive component with an alternatively designed encoder element,

FIG. 7 shows a schematic flow chart of a position- and/or movement determination method with the inductive position determination device, and

FIG. 8 shows a schematic flow chart of a method for manufacturing the encoder element for the inductive position determination device.

### DETAILED DESCRIPTION OF THE INVENTION

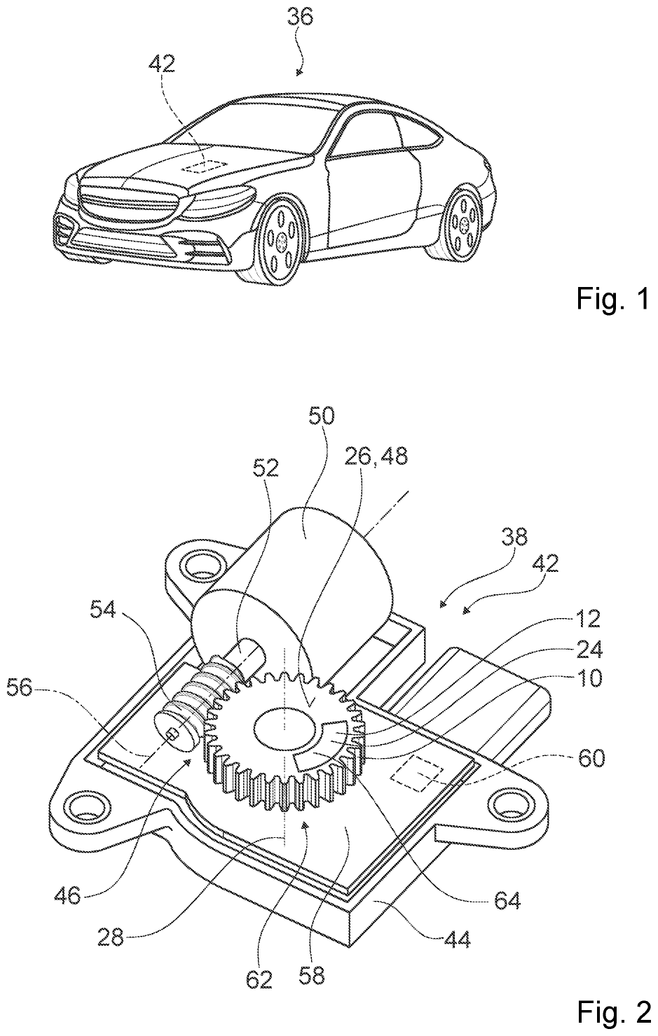

FIG. 1 schematically shows a vehicle 36. The vehicle 36 is at least partially electrically driven, for example, a hybrid vehicle, a plug-in hybrid vehicle, a fuel cell vehicle and/or a purely battery-operated electric vehicle. The vehicle 36 has a drive system 42. The drive system 42 is configured for driving at least one function in the vehicle 36. This function can be associated with a generation of a propulsion of the vehicle 36 or unassociated with the generation of propulsion. The drive system 42 described by way of example in conjunction with the figures is configured for displacing an element to be displaced (not shown), for example, a rotary slide valve, a flap, etc. The drive system 42 includes an inductive position determination device 38 (cf., inter alia, FIG. 2).

FIG. 2 shows a schematic perspective view at least of a portion of the drive system 42 with the inductive position determination device 38. The inductive position determination device 38 is formed as an inductive angular position determination device. The drive system 42 and/or the inductive position determination device 38 has a drive component 10. The drive system 42 has a housing 44. The housing 44 is shown open in the illustration of FIG. 2. A cover of the drive system 42, which usually closes the housing 44 and is preferably ultrasonically welded with the housing 44, is not shown in the figures. The drive component 10 is movably supported, in particular at least in relation to a housing 44 of the drive system 42. The inductive position determination device 38 is configured for determining a position, in particular an angular position, and/or a movement of the drive component 10. The drive module 10 is in the form of a transmission component, in particular a component of a worm gearing 46 of the drive system 42. The drive component 10 is in the form of a gear wheel. The drive component 10 is in the form of a spur gear. Alternative embodiments of the drive component 10 are possible without deviating from the core of the present invention. The drive component 10 is formed from a nonmetallic material or of multiple nonmetallic materials. The drive component 10 is formed from an electrically nonconductive material or of multiple electrically nonconductive materials. The drive component 10 is formed from a plastic or of a combination of multiple types of plastic. The drive component 10 is formed from one or multiple plastic(s), wherein at least one of the plastics of the drive component 10 is an electroplatable plastic, a plastic which can be coated by means of the dusty plasma technique and/or a plastic which can be coated by means of the laser direct structuring technique (LDS), such as, for example, PA GF.

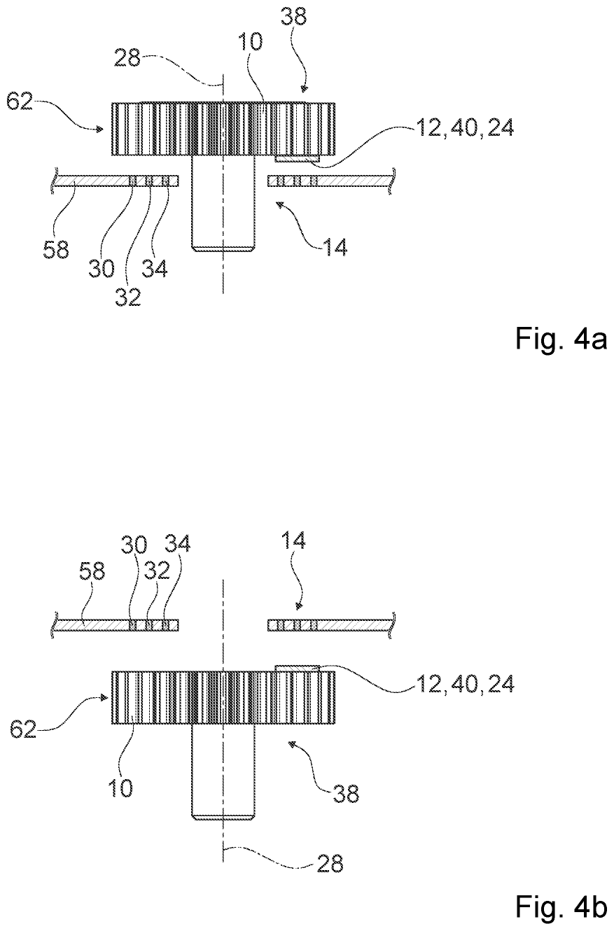

The drive system 42 has a motor 50. The motor 50 is in the form of an electric motor (for example, BLDC or DC). The motor 50 is configured for rotationally driving an output shaft 52 of the drive system 42. The output shaft 52 is provided with a worm wheel 54 of the worm gearing 46. The worm wheel 54 is intermeshed with the drive component 10 which is in the form of a spur gear. A rotation of the worm wheel 54 around a rotation axis 56 of the output shaft 52 generates a rotational motion of the drive component 10, which is in the form of a spur gear, around a further rotation axis 28 which is perpendicular to the rotation axis 56 of the output shaft 52 and around which the drive component 10 is rotationally supported. The drive system 42 has a circuit board 58. The circuit board 58, in particular a main extension plane of the circuit board 58, is arranged perpendicular to the rotation axis 28 of the drive component 10. The circuit board 58, in particular the main extension plane of the circuit board 58, is arranged parallel to the rotation axis 56 of the output shaft 52. The motor 50 has a power electronics system (not shown). The circuit board 58 is configured for accommodating the power electronics system of the motor 50. The drive system 42 has a control and/or regulation unit 60. The control and/or regulation unit 60 is configured for controlling the motor 50 by means of an open-loop or closed-loop system. The control and/or regulation unit 60 is configured for controlling the inductive position determination device 38 by means of an open-loop or closed-loop system, and/or reading it out. The circuit board 58 is configured for accommodating the control and/or regulation unit 60. The drive component 10, in particular a toothing 62 of the drive component 10, is arranged above the circuit board 58 in FIG. 2 by way of example (cf. also FIG. 4a). Alternatively, the drive component 10, in particular the toothing 62 of the drive component 10, can also be arranged underneath the circuit board 58 (cf. FIG. 4b).

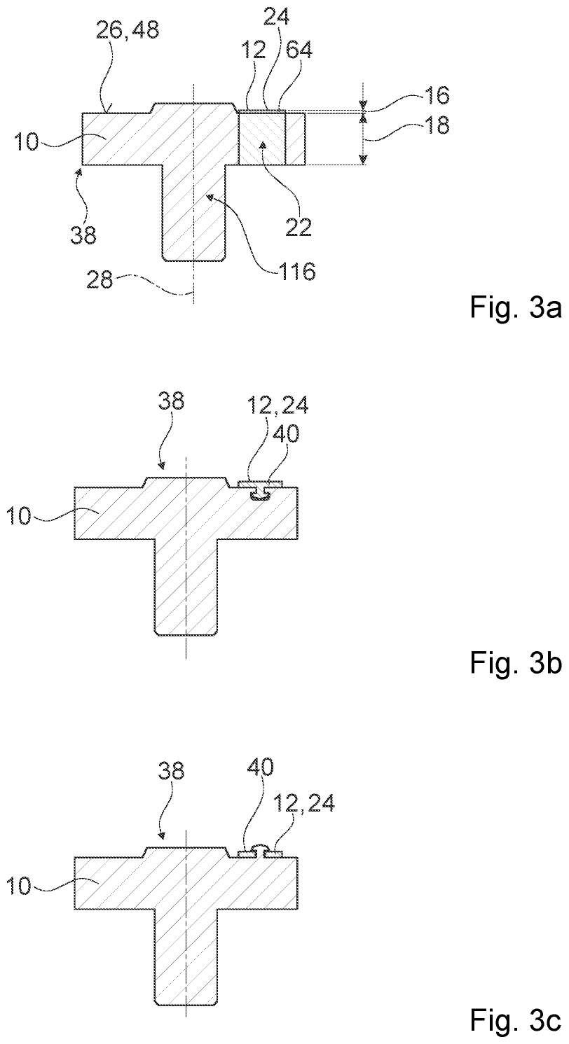

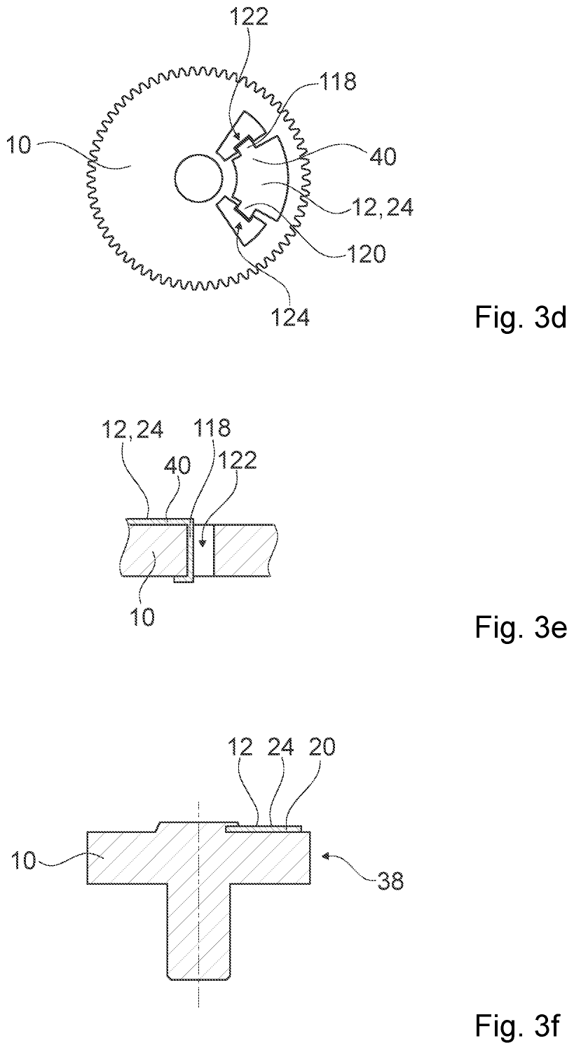

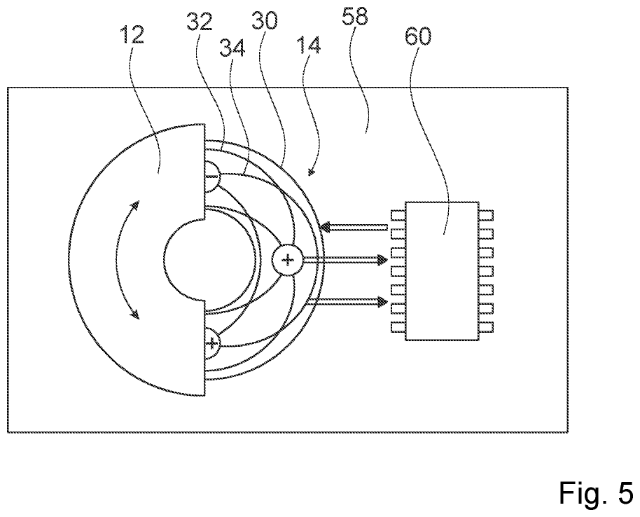

The inductive position determination device 38 has an encoder element 12. The encoder element 12 is integrated in the drive component 10 (cf. FIG. 3f) or is fastened form-lockingly or by substance-to-substance bond on a surface 48 of the drive component 10 (cf, FIG. 3b, 3c or 3e). The encoder element 12 moves along with the drive component 10. The drive component 10 is configured for generating a driving motion, for example, for driving the rotary slide valve or the flap. The encoder element 12 moves along with the drive component 10. The encoder element 12 moves along with the rotational driving motion of the drive component 10. The drive system 42 has a sensor module 14 (see, inter alia, FIG. 5). The encoder element 12 is configured for interacting with the sensor module 14 (inductively or via mutual induction) for the purpose of position determination. The encoder element 12 is formed from a metallic material or of multiple metallic materials. The encoder element 12 is formed from a nonmetallic material or of multiple nonmetallic materials. The encoder element 12 is formed from an electrically conductive material or of multiple electrically conductive materials. The encoder element 12 is formed from copper. Alternatively, the encoder element 12 is formed from aluminum.

The material of the encoder element 12 or, if the encoder element 12 is composed from multiple materials, the materials of the encoder element 12 in all, has/have a density which is substantially greater than a density of the drive component 10, wherein an average density is used, in particular, if the drive component 10 is composed from multiple materials. The density of the encoder element 12 (regardless of whether it is formed from one or multiple material(s)) is at least twice as great as the, in particular, average density of the drive component 10. At the same time, a total mass of the encoder element 12 is substantially less than a total mass of the drive component 10. The total mass of the drive component 10 is at least three times greater than the total mass of the encoder element 12.

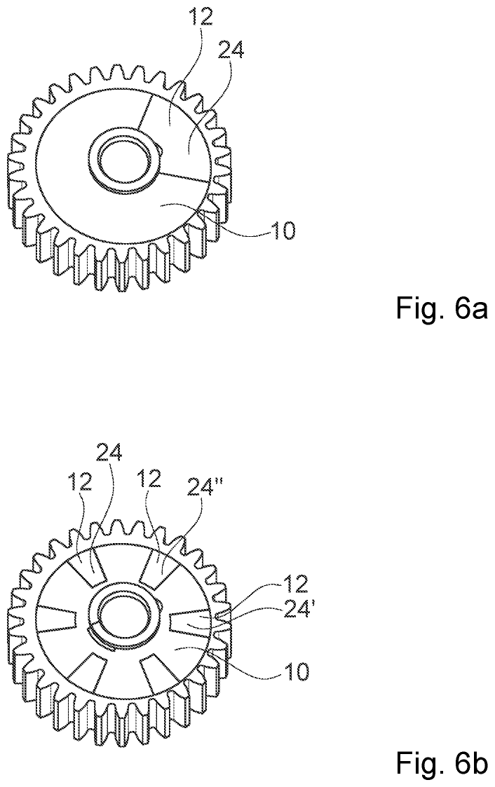

The encoder element 12 is in the form of an annulus segment 24 (see also FIG. 6a). Alternatively or additionally, the encoder element 12 can also be divided into a plurality of mutually spaced annulus segments 24, 24′, 24″, as shown in FIG. 6b. A size of an angular range which is detectable by the inductive position determination device 38 and/or a precision of the determination of the angle by the inductive position determination device 38 depends on the embodiment of the encoder element 12.

FIG. 3a shows a schematic section through the drive component 10 having the encoder element 12. The encoder element 12 is in the form of a coating 64 of the drive component 10. The encoder element 12 is in the form of an electroplating 64 of the drive component 10. The drive component 10 is formed from two different plastics. In a first sub-region 22 of the drive component 10, the drive component is formed from an electroplatable, electrically conductive plastic, such as, for example, Makralon or PC. The coating 64 is applied on the first sub-region 22 of the drive component 10. The coating 64 covers the portion of the surface of the drive component 10 that is formed from the electrically conductive plastic, such as, for example, Makralon or PC. In a second sub-region 116, which differs from the first sub-region 22, the drive component 10 is formed from a non-electroplatable and/or electrically nonconductive plastic, such as, for example, ABS or PA. The surfaces of the second sub-region 116 of the drive component 10 are free of a metallic coating/electroplating 64. FIGS. 3b through 3e show schematic sections through the drive component 10 having alternatively designed encoder elements 12. The encoder elements 12 are connected form-lockingly and/or by substance-to-substance bond to the drive component 10. The encoder elements 12 are formed as support parts 40 which are connected form-lockingly and/or by substance-to-substance bond to the drive component 10. FIG. 3d schematically shows a top view of the drive component 10 with the encoder element 12, wherein the encoder element 12 is form-lockingly connected to the drive component 10 via connecting tabs 118, 120 of the encoder element 12. In this case, the drive component 10 has (continuous) recesses 122, 124 into which the connecting tabs 118, 120 engage. The connecting tabs 118, 120 are formed from a plastically deformable material, for example, from the same material as the encoder element 12. It is conceivable that the connecting tabs 118, 120 are integrally formed with the encoder element 12. FIG. 3e shows a schematic sectional view through the drive component 10 in the region of one of the recesses 122, 124. The connecting tabs 118, 120 are bent into the recesses 122, 124. The connecting tabs 118, 120 are bent out of the recess 122, 124 on a side of the drive component 10 situated opposite the encoder element 12. The connecting tabs 118, 120 encompass the recesses 122, 124 on one side. Due to the form-locking connection methods shown in FIGS. 3d and 3e, a particularly close positioning of the encoder element 12 to the circuit board 58 can be advantageously made possible. Preferably, a distance between a surface of the encoder element 12 and a surface of the circuit board 58 situated opposite the encoder element 12 is less than five times, preferably less than three times and particularly preferably less than twice a thickness 16 of the encoder element 12 in a direction perpendicular to a main movement plane of the drive component 10.

FIG. 3f shows a schematic section through the drive component 10 having a further, alternatively designed encoder element 12. The encoder element 12 is in the form of an insert 20 which has been placed into the drive component 10. In this case, the encoder element 12 is partially surrounded by the drive component 10. In this case, the encoder element 12 is partially injected into the drive component 10. In this case, the encoder element 12 is located in part, preferably to a large extent, on a surface of the drive component 10. As a result, a distance between the encoder element 10 and the circuit board 58 that is as minimal as possible can be advantageously achieved, as a result of which, in particular, a high signal quality can be ensured.

The encoder element(s) 12 in each case has/have a main extension plane which extends parallel to a front face 26 of the drive component 10 which is formed as a gear wheel. The main extension plane(s) of the encoder element(s) 12 extend(s) perpendicularly to the rotation axis 28 of the respective rotationally supported drive component 10. The encoder element(s) 12 has/have the thickness 16 in a direction perpendicular to a main movement plane of the drive component 10 that is substantially less than a thickness 18 of the drive component 10 in the same direction. The encoder element(s) 12 has/have a thickness 16 of less than 500 μm. The encoder element 12 formed as a coating 64 has a thickness 16 of approximately 50 μm.

FIGS. 4a and 4b schematically show the arrangement of the drive component 10 with the encoder element 12 relative to the circuit board 58 with the sensor module 14 in a view from the side, wherein the circuit board 58 is shown in a cut view. The sensor module 14 has a transmitting coil 30. The transmitting coil 30 is configured for generating an excitation signal. The transmitting coil 30 is integrated into the circuit board 58 or arranged on the circuit board 58. The sensor module 14 has two receiving coils 32, 34. The receiving coils 32, 34 are each configured for receiving a response signal which is inductively generated by the encoder element 12 in response to the excitation signal. The excitation signal is at least partially absorbed by the encoder element 12 and generates eddy currents in the encoder element 12, the eddy currents generating a response signal due to the mutual induction. The response signal is registered by the receiving coils 32, 34 and evaluated by the control and/or regulation unit 60 in order to ascertain a position. The receiving coils 32, 34 are offset with respect to each other (see also FIG. 5). The receiving coils 32, 34 overlap, as viewed in the direction of the rotation axis 28 of the drive component 10, only at individual intersection points. The receiving coils 32, 34 are each integrated into the circuit board 58 or arranged on the circuit board 58. The transmitting coil 30 is spatially separated from the receiving coils 32, 34. The receiving coils 32, 34 and the transmitting coil 30 lie in a common plane which preferably extends parallel to the front face 26 of the drive component 10, which is in the form of a gear wheel, and/or perpendicularly to the rotation axis 28 of the drive component 10.

FIG. 5 shows one further schematic view of the sensor module 14. The control and/or regulation unit 60 outputs the excitation signal to the transmitting coil 30, the excitation signal being in the form of a sinusoidal signal. The receiving coils 32, 34 each register different position-angle-dependent response signals which have been generated in the encoder element 12 due to mutual induction. The receiving coils 32, 34 convert the response signal into an electrical signal and transmit this back to the control and/or regulation unit 60. By viewing the response signals from both receiving coils 32, 34 in combination, the control and/or regulation unit 60 determines the current position angle of the encoder element 12 and thus of the drive component 10. The determined value can then be read out of the control and/or regulation unit 60, for example, by an on-board controller of the vehicle 36.

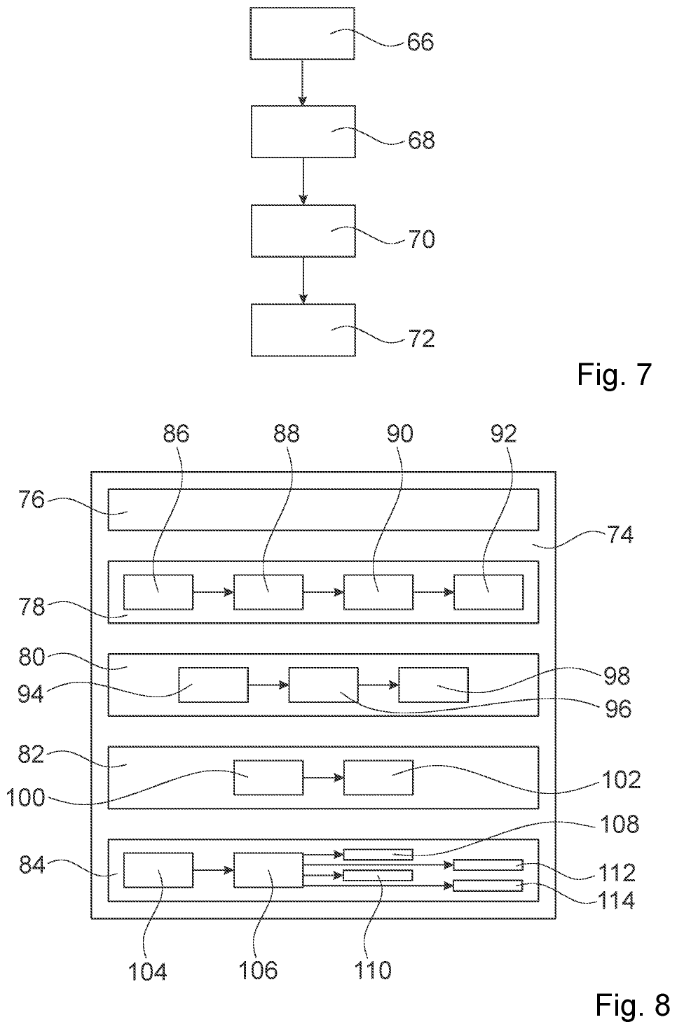

FIG. 7 shows a flow chart of a position- and/or movement determination method with the inductive position determination device 38. In at least one method step 66, an excitation signal is output from the transmitting coil 30. In at least one further method step 68, the excitation signal is absorbed by the encoder element 12, which moved along with the drive component 10, and eddy currents are generated in the encoder element 12, as a result of which a response signal in the form of a mutual induction signal is emitted from the encoder element 12. In at least one further method step 70, the response signal is registered by the receiving coils 32, 34. Due to the fact that the receiving coils 32, 34 are offset with respect to each other, the response signal of each receiving coil 32, 34 looks different. In at least one further method step 72, the different response signals of the two receiving coils 32, 34 are received by the control and/or regulation unit 60 and are evaluated for determining the current position of the encoder element 12 and thus of the drive component 10.

FIG. 8 shows a schematic flow chart of a method for manufacturing the encoder element 12 for the inductive position determination device 38. In at least one method step 74 of the manufacturing method, for forming the thin, plate-shaped encoder element 12, a metallic, nonmagnetic and electrically conductive material is introduced into/applied onto the drive component 10 which is formed from the nonconductive material(s). The method step 74 can include multiple different methods for encoder element generation.

In a first method, in a substep 76 of the method step 74, the encoder element 12 is electroplated onto the drive component 10 which is at least partially formed from one or multiple electroplatable plastic(s). The drive component 10 is dipped into a galvanic solution and a voltage is applied, such that the encoder element 12 is formed on the drive component 10 due to deposition of a metal.

In a second method, in a substep 78 of the method step 74, the encoder element 12 is applied onto the drive component 10, which is formed from one or multiple plastic(s), by means of the dusty plasma technique. In one method step 86, a non-thermal plasma beam is generated and directed onto the drive component 10. In one further method step 88, a metal-nano- or metal-micro-powder is introduced into the plasma beam, i.e., blown therein. In one further method step 90, the plasma beam burns on the particles of the introduced metal-nano- or metal-micro-powder. In one further method step 92, the material generated via the melting of the metal-nano- or metal-micro-powder bonds with the drive component 10 and forms the encoder element 12.

In a third method, in a substep 80 of the method step 74, the encoder element 12 is applied onto the drive component 10, which is formed from one or multiple plastic(s), by means of the laser direct structuring technique (LDS). In a method step 94, the drive component 10 is formed from a plastic to which an LDS additive has been added, e.g., via injection molding. In a further method step 96, a region of the drive component 10, on which the encoder element 12 is to arise, is targeted by a laser and thereby activated. In one further method step 98, the laser-activated drive component 10 is dipped into zero-current copper bath. In the method step 98, the encoder element 12 forms from the copper bath by bonding to the drive component 10 in the activated region and forming a copper coating.

In a fourth method, in a substep 82 of the method step 74, the encoder element 12 is introduced into the drive component 10, which is formed from one or multiple plastic(s), as an insert 20 in an injection molding process. The encoder element 12 is prefabricated in a method step 100. In one further method step 102, the prefabricated encoder element 12 is partially extrusion-coated in a multiple-component injection molding process while forming the drive component 10.

In a fifth method, in a substep 84 of the method step 74, the encoder element 12 is applied onto the drive component 10, which is formed from one or multiple plastic(s), as a support part 40 by means of a form-locking connection. The encoder element 12 is prefabricated in a method step 104. In one further method step 106, the drive component 10 is prefabricated. In one further method step 108, the encoder element 12 is adhesively bonded onto the drive component 10. In one further alternative method step 110, the encoder element 12 is form-lockingly inserted onto the drive component 10 and/or the connecting tabs 118, 120 of the encoder element are bent into the recesses 122, 124. In one further alternative method step 112, the encoder element 12 is heat staked/heat riveted (plastic riveting) for the form-locking connection with the drive component 10. In one further alternative method step 114, the encoder element 12 is ultrasonically riveted (plastic riveting) for the form-locking connection with the drive component 10.

1. An inductive position determination device, in particular an inductive angular position determination device, for determining a position and/or a movement of a movably supported drive component, comprising:
the drive component which is formed from at least substantially at least electrically nonconductive materials, and
an encoder element which is in particular integrated at least into the drive component and/or fastened on the drive component, which moves along with a movement of the drive component and which is formed from a metallic, at least substantially nonmagnetic and at least substantially electrically conductive material, wherein the encoder element is configured for interacting with a sensor module for the purpose of position determination, and
wherein a density of the material of the encoder element is substantially greater than an, in particular average, density of the drive component.

2. The inductive position determination device as claimed in claim 1, wherein the density of the encoder element is at least twice as great as the density of the drive component.

3. The inductive position determination device as claimed in claim 1, wherein a total mass of the encoder element is substantially less than a total mass of the drive component.

4. The inductive position determination device as claimed in claim 1, wherein the encoder element has at least in a direction perpendicular to a main movement plane of the drive component a thickness which is substantially less than a thickness of the drive component in the same direction.

5. The inductive position determination device as claimed in claim 4, wherein the encoder element is in the form of a support part which is connected form-lockingly and/or by substance-to-substance bond to the drive component and/or in the form of an insert which has been introduced into the drive component.

6. The inductive position determination device as claimed in claim 4, wherein the encoder element has a thickness of less than 500 μm, preferably less than 250 μm and preferentially less than 100 μm.

7. The inductive position determination device as claimed in claim 1, wherein the encoder element is in the form of a coating of the drive component.

8. The inductive position determination device as claimed in claim 1, wherein the drive component is formed from one or multiple plastic(s).

9. The inductive position determination device as claimed in claim 8, wherein the drive component is made at least partially of an electroplatable plastic, of a plastic which can be coated by means of the dusty plasma technique and/or of a plastic which can be coated by means of the laser direct structuring technique.

10. The inductive position determination device as claimed in claim 1, wherein the drive component is formed as a transmission component, in particular as a gear wheel.

11. The inductive position determination device as claimed in claim 1, wherein the material of the encoder element is copper and/or aluminum.

12. The inductive position determination device as claimed in claim 1, wherein the encoder element is in the form of an annulus segment.

13. The inductive position determination device as claimed in claim 1, wherein a main extension plane of the encoder element extends at least substantially parallel to a front face of the drive component which is in the form of a gear wheel, and/or
wherein the drive component is rotationally supported and the main extension plane of the encoder element extends at least substantially perpendicular to a rotation axis of the rotationally supported drive component.

14. The inductive position determination device as claimed in claim 1, wherein the sensor module which has at least one transmitting coil for generating an excitation signal.

15. The inductive position determination device as claimed in claim 14, wherein the sensor module has at least two receiving coils for receiving a response signal which has been inductively generated by the encoder element in response to the excitation signal.

16. An at least partially electrically driven vehicle, in particular a hybrid vehicle, plug-in hybrid vehicle, fuel cell vehicle and/or purely battery-operated electric vehicle, having the inductive position determination device as claimed in claim 1.

17. An inductive position- and/or movement determination method with the inductive position determination device as claimed in claim 1.

18. A method for manufacturing at least one encoder element for an inductive position determination device as claimed in claim 1, wherein, for forming the, in particular thin, preferably plate-shaped, encoder element, a metallic, at least substantially nonmagnetic and at least substantially electrically conductive material is introduced into/applied onto a drive component, which is formed from at least substantially electrically nonconductive materials.

19. The method as claimed in claim 18, wherein the encoder element is electroplated onto the drive component, which is in particular formed from one or multiple plastics.

20. The method as claimed in claim 18, wherein the encoder element is applied onto the drive component, which is in particular formed from one or multiple plastics, by means of the dusty plasma technique.

21. The method as claimed in claim 18, wherein the encoder element is applied onto the drive component, which is in particular formed from one or multiple plastics, by means of the laser direct structuring technique (LDS).

22. The method as claimed in claim 18, wherein the encoder element is introduced as an insert in an injection molding process into the drive component, which is in particular formed from one or multiple plastics.

23. The method as claimed in claim 18, wherein the encoder element is placed as a support part onto the drive component by means of a form-locking connection, the drive component being formed, in particular, from one or multiple plastic(s).
